(19) United States
(12) Patent Application Publication
(10) Pub. No.: US 2014/0143654 A1
(43) Pub. Date: May 22, 2014

(54) SYSTEMS AND METHODS FOR GENERATING MOBILE APP PAGE TEMPLATE, AND STORAGE MEDIUM THEREOF

(71) Applicant: INSTITUTE FOR INFORMATION INDUSTRY, Taipei (TW)

(72) Inventors: Ren-Dar YANG, Hsinchu City (TW); Tse-Ming TSAI, Taipei City (TW); Shih-Chun CHOU, Taipei City (TW); Bo-Fu LIU, Tainan City (TW); Jih-Yiing LIN, Zhuqi Township (TW); Pei JIANG, Zhudong Township (TW); Yu-Ting LIN, Chiayi City (TW)

(73) Assignee: INSTITUTE FOR INFORMATION INDUSTRY, Taipei (TW)

(21) Appl. No.: 13/895,539

(22) Filed: May 16, 2013

(30) Foreign Application Priority Data
Nov. 22, 2012 (TW) 101143610

(51) Int. Cl. G06F 17/22

(52) U.S. Cl. CPC G06F 17/2247
USPC 715/234

(57) ABSTRACT

A system for generating a mobile APP page template is provided with an interface module, a processing module, and a storage module. The interface module receives at least one mobile APP page. The processing module is coupled to the interface module, and retrieves page components and mobile-device sensor information for activating at least one of the page components from the mobile APP page, and classifies the page components into categories and keeps a respective usage count and at least one attribute for each of the page components. Also, the processing module generates at least one mobile APP page template according to the categories, the usage counts, the attributes, and the mobile-device sensor information of the page components. Particularly, the mobile APP page template comprises the mobile-device sensor information and at least one template component activated by the mobile-device sensor information.

### CROSS REFERENCE TO RELATED APPLICATIONS

This application claims priority of Taiwan Patent Application No. 101143610, filed on Nov. 22, 2012, the entirety of which is incorporated by reference herein.

### BACKGROUND OF THE INVENTION

1. Field of the Invention

The invention generally relates to the generation of mobile Application (APP) page templates, and more particularly, to systems, methods, and a machine-readable storage medium thereof for retrieving page components from existing mobile APP pages to accordingly generate new mobile APP page templates for mobile APP page editing.

2. Description of the Related Art

With worldwide use of mobile devices, content rich publications, such as electronic books, electronic magazines, electronic catalogs, and web pages, etc., are commonly being viewed on mobile devices by customers. Hence, publishers, media companies, and sales companies, etc., aim to design mobile APP pages for providing electronic versions of their merchandise to customers regularly or non-regularly, such as books, magazines, catalogs, and shopping information. However, the generation and editing of the mobile APP pages are performed manually. For example, a chief editor first determines a theme for a particular publication, then copy editor collects materials to draft a layout based on the determined theme, and finally, art designer colors the draft layout into visualized content according to the determined theme. Following by the finalized manuscript, each mobile page is developed by the mobile programmers from their engineering perspective which becomes a pivotal conflict to designers. In addition, programmers usually take a lot of time restructuring the native code in order to accomplish multiple goals including better performance, no bugs, correctly conveying the determined theme or keeping to the style of delicate design. The mobilized content process generally consumes a great deal of manpower and time due to the communication gap between designers and programmers. Thus, it is desirable to have a convenient way to speed up the generation and editing of mobile APP pages.

Conventionally, the webpage editing tools are used for the generation of mobile APP pages, but there are several drawbacks. For example, the conventional editing tools usually provide fixed templates for a user to select from, which lack editing flexibility. In addition, although a new mobile APP page may be generated by replacing the content of an existing mobile APP page, the existing mobile APP page is always selected from the fixed templates that cannot be renewed. Furthermore, the conventional editing tools are not capable of editing mobile APP pages with features of mobile devices, such as, the use of mobile-device sensors and touch screens for interacting with users. In short, the conventional editing tools are not able to design the components of the mobile APP pages with the features of mobile devices.

### BRIEF SUMMARY OF THE INVENTION

In order to solve the aforementioned problems, the invention proposes systems, methods, and a machine-readable storage medium thereof for retrieving page components and mobile-device sensor information for activating the page components from existing mobile APP pages to accordingly generate new mobile APP page templates, so that editors may use the new mobile APP page templates for editing and content setting to swiftly produce mobile APP pages.

In one aspect of the invention, a system for generating a mobile APP page template is provided. The system comprises an interface module, a processing module, and a storage module. The interface module is configured to receive at least one mobile APP page. The processing module is coupled to the interface module, and is configured to retrieve page components and mobile-device sensor information for activating at least one of the page components from the mobile APP page, and classify the page components into categories and keep a respective usage count and at least one attribute for each of the page components. Also, the processing module is configured to generate at least one mobile APP page template according to the categories, the usage counts, the attributes, and the mobile-device sensor information of the page components, wherein the mobile APP page template comprises the mobile-device sensor information and at least one template component activated by the mobile-device sensor information.

In another aspect of the invention, a method for generating a mobile APP page template is provided. The method comprises the steps of: receiving at least one mobile APP page via an operation interface; retrieving, by a processing module, page components and mobile-device sensor information for activating at least one of the page components from the mobile APP page; classifying, by the processing module, the page components into categories and keeping, by the processing module, a respective usage count and at least one attribute for each of the page components; and generating, by the processing module, at least one mobile APP page template according to the categories, the usage counts, the attributes, and the mobile-device sensor information of the page components, and displaying, by the process module, the mobile APP page template via the operation interface, wherein the mobile APP page template comprises the mobile-device sensor information and at least one template component activated by the mobile-device sensor information.

In yet another aspect of the invention, a machine-readable storage medium is provided. The machine-readable storage medium comprises a computer program, which, when executed, causes an electronic device to perform a method for generating a mobile APP page template. The method comprises the steps of: receiving at least one mobile APP page via an operation interface; retrieving, by a processing module, page components and mobile-device sensor information for activating at least one of the page components from the mobile APP page; classifying, by the processing module, the page components into categories and keeping, by the processing module, a respective usage count and at least one attribute for each of the page components; and generating, by the processing module, at least one mobile APP page template according to the categories, the usage counts, the attributes, and the mobile-device sensor information of the page components, and displaying, by the process module, the mobile APP page template via the operation interface, wherein the mobile APP page template comprises the mobile-device sensor information and at least one template component activated by the mobile-device sensor information.

Other aspects and features of the present invention will become apparent to those ordinarily skilled in the art upon review of the following descriptions of specific embodiments of the systems, methods, and a machine-readable storage medium thereof for generating a mobile APP page template.

### BRIEF DESCRIPTION OF DRAWINGS

The invention can be more fully understood by reading the subsequent detailed description and examples with references made to the accompanying drawings, wherein:

FIG. 1 is a diagram illustrating a system for generating a mobile APP page template according to an embodiment of the invention;

FIG. 2 is a flow chart illustrating the method for generating a mobile APP page template according to an embodiment of the invention; and

FIG. 3 is a schematic diagram illustrating the retrieving of page components from mobile APP pages according to an embodiment of the invention.

### DETAILED DESCRIPTION OF THE INVENTION

The following description is made for the purpose of illustrating the general principles, characteristics, and advantages of the invention, with preferred embodiments and accompanying drawings.

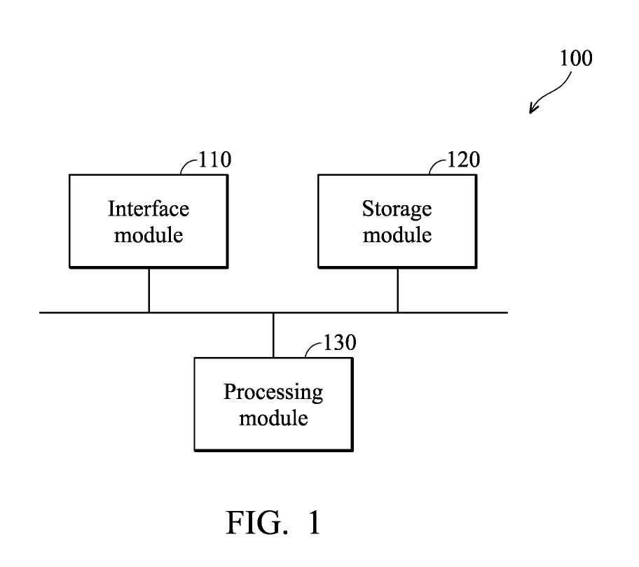

FIG. 1 is a diagram illustrating a system for generating a mobile APP page template according to an embodiment of the invention. The system 100 comprises an interface module 110, a storage module 120, and a processing module 130. The interface module 110 is responsible for providing an operation interface for receiving mobile APP pages. In a preferred embodiment, the operation interface may be a Human Computer Interface (HCI) or software interface displayed on a display device or touch screen (not shown). It also may be a combination of specific software and the display device or touch screen, for receiving one or more existing mobile APP pages. For example, the existing mobile APP pages may be selected from the mobile APP pages which the user prefers or deems popular, or may be selected from a database pre-storing one or a plurality of mobile APP pages. In addition, the interface module 110 may be used further for displaying the generated mobile APP page template or the mobile APP pages derived therefrom to the user. The display device may be a Cathode Ray Tube (CRT) or Liquid Crystal Display (LCD) screen/panel, touch screen, Plasma screen/panel, or any device with displaying functionality.

The processing module 130 may be a general-purpose processor, Micro-Control Unit (MCU), or any firmware with processing capability (e.g., a processor or processing chip with software programmed therein), which is responsible for processing the received mobile APP pages to generate a mobile APP page template. The processing can be the following: retrieving page components and mobile-device sensor information for activating at least one of the page components from the mobile APP page, classifying the page components into categories and keeping, a respective usage count and at least one attribute for each of the page components, and generating at least one mobile APP page template according to the categories, the usage counts, the attributes, and the mobile-device sensor information of the page components, wherein the mobile APP page template comprises the mobile-device sensor information and at least one template component activated by the mobile-device sensor information. After processing the received mobile APP pages, the processing module 130 further displays the mobile APP page template via the interface module 110. It is noted that, the page components do not include the content, such as, texts, multimedia files, and images, etc., of the mobile APP pages.

The storage module 120 may be a memory (e.g., Random Access Memory (RAM), Flash memory, or Non-Volatile Random Access Memory (NVRAM), etc.), a magnetic storage device (e.g., magnetic tap or hard disk), an optical storage device (e.g., Compact Disc Read-Only Memory (CD-ROM)), or any device with data storing functionality, such as a computer, server, or database, etc. The storage module 120 is used for storing the data generated by the processing module 130 when processing the received mobile APP pages. Alternatively, the storage module 120 may be used for storing the instruction sets for the operation of the processing module 130.

In another embodiment, the system 100 may further comprise a network communication module (not shown) (e.g., any product available in the market using known technology for network communication) which is responsible for providing network communications between the interface module 110, the storage module 120, and the processing module 130 when they are located separately in different places, so that they may be linked together to function as a distributed system. In a preferred embodiment, the interface module 110 may be disposed in a user device, such as a smartphone, Personal Digital Assistant (PDA), Personal Navigation Device (PND), portable gaming device, Personal Computer (PC), tablet PC, notebook PC, netbook PC, multimedia player, or Multi Media Kiosk (e.g., ibon, FamiPort, and Life-ET), etc., while the storage module 120 and the processing module may be disposed in a server device. Thus, the system resources of the user device may be efficiently saved by having the complicated computations performed by the server device and then obtaining the results from the server device via network communications. Alternatively, the system 100 may be implemented in a single mobile device, such as a smartphone, FDA, PND, portable gaming device, tablet PC, notebook PC, netbook PC, or multimedia player, etc.

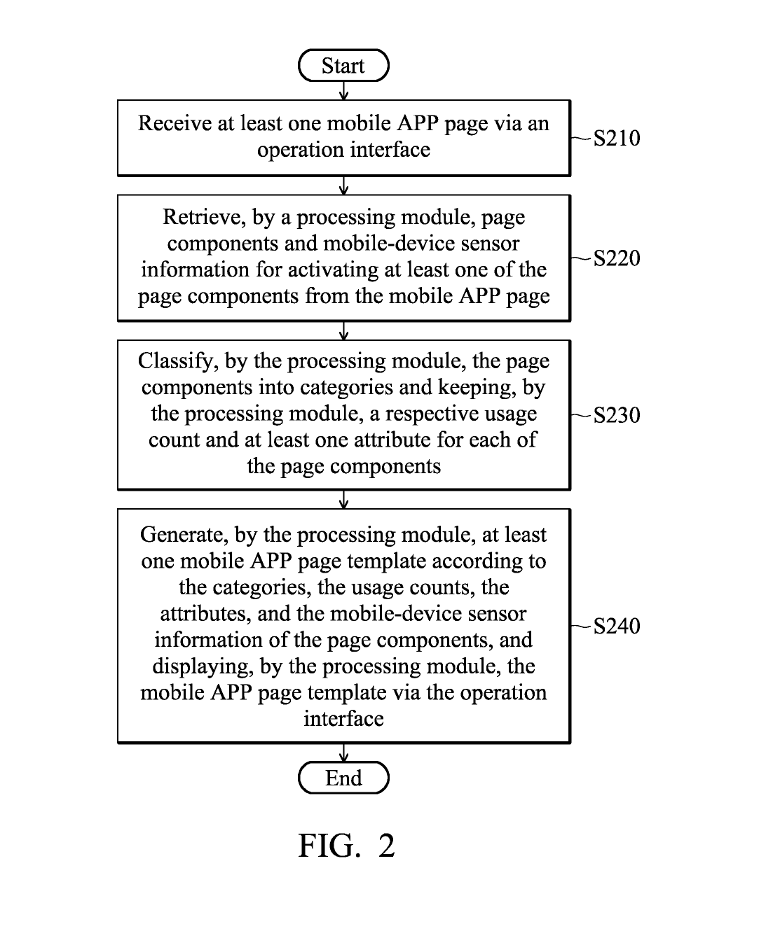

FIG. 2 is a flow chart illustrating the method for generating a mobile APP page template according to an embodiment of the invention. The method may be executed by an electronic device, such as the system 100, which comprises an operation interface and a processing module. To begin, at least one mobile APP page is received via the operation interface (step S210). In a preferred embodiment, the mobile APP page may be selected from an existing and popular/successful publication (e.g., electronic books/magazines/journals/catalogs) APP, and the mobile APP page may be any content-rich mobile APP page therein.

Subsequently, the processing module retrieves page components and mobile-device sensor information for activating at least one of the page components from the mobile APP page (step S220). In one embodiment, the processing module may perform the factoring process to retrieve all page components in the mobile APP page, wherein each of the page components refers to a respective component appearing in the layout of the mobile APP page. For example, the page components may include texts, images, tables, audios, videos, web content, and real-time notification etc., wherein the instant statuses may refer to a block in which instant updates of certain information, such as facebook updates, twitter updates, message board updates, and banner advertisements (e.g., promotion for upcoming TV series), etc., are displayed.

To further clarify, the page components which are not activated by the mobile-device sensor information may be classified into a static-component category, and the page components which are activated by the mobile-device sensor information may be classified into a dynamic-component category. For example, if the mobile APP page contains a static component, i.e., a component of the static-component category, of texts, specific text may be selected to be as static components. The specific texts may be placed into the bonding box corresponding to the static component for editing. If the mobile APP page contains a dynamic component, i.e., a component of the dynamic-component category, of an image and the mobile-device sensor information for activating the image contains gesture identifications, a specific image can be selected and placed into the bonding box corresponding to the dynamic component, and be configured that the gesture identifications is swipe down. Specifically, the image in the bonding box corresponding to the dynamic component may be shown to be moving when detecting a swipe down gesture. In some embodiments, the mobile APP page may contain only static components, or only dynamic components, or both static and dynamic components. In addition, the processing module may further retrieve function setting information corresponding to the mobile-device sensor information from the mobile APP page, and use the function setting information to generate the mobile APP page template. The function setting information may be the information for zoom-in or zoom-out of an image presentation in the mobile APP page, the information for a banner's location of presenting advertisement messages in the mobile APP page according to a Global Positioning System (GPS), the information for a moving path of an image in the mobile APP page, which is dynamically adjusted by an accelerator, the information for a presentation area of an image captured by a camera in the mobile APP page, or the information for a presentation area of a button in the mobile APP page for activating a recording or playing function of a microphone.

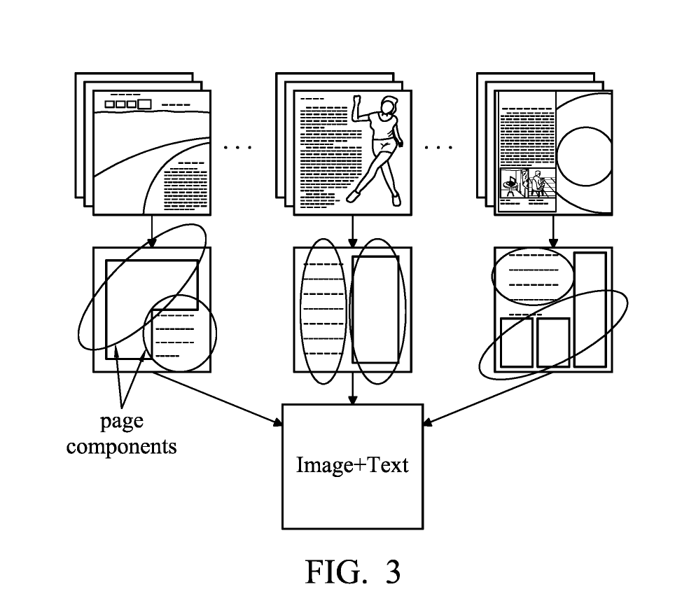

FIG. 3 is a schematic diagram illustrating the retrieving of page components from mobile APP pages according to an embodiment of the invention. As shown in FIG. 3, the retrieved page components of the mobile APP pages are all in a combination of images and texts. The mobile-device sensor information is generated by a mobile-device sensor and is for activating the corresponding page components to present the effect of user interactions with the page components. For example, the user interactions may include scrolling hidden messages, tapping buttons, spreading or pinching graphic content, dragging displayed content, vibrating of the mobile device, panning of a webpage, and switching to another page component, etc. The mobile-device sensor may include a touch panel, GPS sensor, accelerator, g-sensor, vibrator, and sound detector (generally refers to microphone and/or speaker). For example, an accelerator or g-sensor may be used to detect the shaking or directional offset of the mobile device for generating the mobile-device sensor information, thereby causing a rolling or falling effect of the image of popcorn (i.e., the corresponding page component).

In another embodiment, the user may input a page selection command via the operation interface or another interface, and the processing module may select parts of the mobile APP page or the entire mobile APP page according to the page selection command for the retrieving of page components in step S220.

Next, the processing module classifies the page components into categories and keeps a respective usage count and at least one attribute for each of the page components (step S230). In one embodiment, the classifying of the page components may be performed by classifying the page components which are activated by the mobile-device sensor information into a category of dynamic components, and classifying the page components which are not activated by the mobile-device sensor information into another category of static components. The usage count represents the number of times for a certain page component to be found in the mobile APP page. The at least one attribute may contain the location configuration, style configuration, and interaction correlation configuration of a respective page component. Specifically, the location configuration indicates the location of each of the page components in the mobile APP page, the style configuration indicates at least one of the bonding boxes, fonts, and background colors of each of the page components, and the interaction correlation configuration indicates at least one of the offset corresponding to the mobile-device sensor information (e.g., offset corresponding to the leaning of the mobile device detected by a G-sensor), time-effectiveness corresponding to the mobile-device sensor information (e.g., time period for displaying a particular page component according to a detected drag gesture), displays corresponding to the mobile-device sensor information (e.g., controlling the displaying or hiding of a particular page component according to a detected touch gesture), and/or trigger conditions corresponding to the mobile-device sensor information (e.g., controlling the shape changing of a particular page component according to the sensitivity of the sound detected by a microphone).

After that, the processing module generates at least one mobile APP page template according to the categories, the usage counts, the attributes, and the mobile-device sensor information of the page components, and displays the mobile APP page template via the operation interface, wherein the mobile APP page template comprises the mobile-device sensor information and at least one template component activated by the mobile-device sensor information (step S240). Consequently, the method for generating a mobile APP page template of the invention may analyze the popular/successful mobile APP pages, and then generate a mobile APP page template therefrom.

In one embodiment, the step S240 may comprise the following sub-steps. The sub-steps comprise: generating a meta-template according to the categories and the usage counts, and then generating at least one mobile APP page template corresponding to the meta-template according to the attributes. Specifically, the meta-template may refer to a set of page components which may be used in a mobile APP page template, wherein the page components in the set do not include materials/content and attributes (including location configuration, style configuration, and/or interaction correlation configuration). The processing module may select the most used page components according to the categories and the usage counts to form one or more meta-template, and then based on the page components in the meta-template and the attributes of the page components in the mobile APP page received in the step S210, set the location configuration, the style configuration, and/or the interaction correlation configuration of the page components in the meta-template to form a mobile APP page template appeared to be similar to the received mobile APP page (i.e., to generate a mobile APP page template). For example, the processing module may first retrieve the page components from at least one mobile APP page, and then use the page components to form at least one meta-template according to the categories and the usage counts of the page components. Later, when it is required to generate a mobile APP page template, the processing module may select one meta-template which appears to be similar to the received mobile APP page, and then set different location configuration, style configuration, and interaction correlation configuration for the page components in the selected meta-template. With different combinations of the location configuration, the style configuration, and the interaction correlation configuration, a plurality of mobile APP page templates may be generated. If the user is not satisfied with the generated mobile APP page templates, the processing module may further generate more mobile APP page templates using the other meta-templates.

Alternatively, the electronic device may generate all possible meta-template according to the categories of the page components, and then display the meta-templates to the user via the operation interface. After the user has selected one of the meta-templates, the electronic device may generate a mobile APP page template according to the attributes of the page components in the mobile APP page(s) which corresponds to the selected meta-template. Taking the aforementioned static page components and dynamic page components for example, the possible combinations of page components in a mobile APP page (i.e., the number of possible meta-templates) may be up to (C₀²+C₁²+C₂²)×(C₁⁶+C₂⁶+C₃⁶+C₄⁶+C₅⁶+C₆⁶), since a mobile APP page may only comprise static page component(s) or both the static and dynamic page components. Therefore, it is more flexible for the user when it comes to the selection of a meta-template for generating a mobile APP page template.

In another embodiment for the step S220, the electronic device may further retrieve the function setting information corresponding to the mobile-device sensor information from the received mobile APP page. The function setting information may comprise one of the following: the information concerning an area in the mobile APP page for zoom-in or zoom-out of an image presentation; the information concerning a banner's location in the mobile APP page for presenting advertisement messages provided by a GPS; the information concerning a moving path for an image in the mobile APP page, which is dynamically adjusted by an accelerator; the information concerning a presentation area in the mobile APP page for activating a camera to capture an image; and the information concerning a presentation area of a button in the mobile APP page for activating a recording or playing function of a microphone. After that, in the step S240, the generation of the mobile APP page template may be performed further according to the function setting information.

The method for generating a mobile APP page template or any forms for carrying the method, or any parts thereof may be implemented in computer program, wherein the computer program may be stored in any machine-readable storage medium, such as a floppy disc, hard disc, optical disc, or computer program product with any external form. Particularly, when the computer program is loaded and executed by an electronic device, e.g., a computer, the electronic device becomes an apparatus or system for performing the steps of the method for generating a mobile APP page template. Alternatively, the computer program may be transferred via certain transferring media, such as electric wires/cables, optical fibers, or others.

Correspondingly, the invention also proposes a machine-readable storage medium comprising a computer program, which, when executed, causes an electronic device to perform the method for generating a mobile APP page template. The steps of the method are as described above with respect to FIG. 2 and, thus, detailed description of the method is omitted here for brevity.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A system for generating a mobile Application (APP) page template, comprising:
an interface module, receiving at least one mobile APP page;
a processing module, coupled to the interface module, retrieving page components and mobile-device sensor information for activating at least one of the page components from the mobile APP page, classifying the page components into categories and keeping a respective usage count and at least one attribute for each of the page components, and generating at least one mobile APP page template according to the categories, the usage counts, the attributes, and the mobile-device sensor information of the page components, wherein the mobile APP page template comprises the mobile-device sensor information and at least one template component activated by the mobile-device sensor information; and
a storage module, coupled to the processing module, storing data generated by the processing module when processing the mobile APP page.

2. The system of claim 1, wherein the mobile-device sensor information is generated by a mobile-device sensor.

3. The system of claim 1, wherein the processing module further retrieves function setting information corresponding to the mobile-device sensor information from the mobile APP page, and the mobile APP page template is generated further according to the function setting information, wherein the function setting information comprises at least one of the following:
information concerning an area in the mobile APP page for zoom-in or zoom-out of an image presentation;
information concerning a banner's location in the mobile APP page for presenting advertisement messages provided by a Global Positioning System (GPS);
information concerning a moving path for an image in the mobile APP page, which is dynamically adjusted by an accelerator;
information concerning a presentation area in the mobile APP page for activating a camera to capture an image; and
information concerning a presentation area of a button in the mobile APP page for activating a recording or playing function of a microphone.

4. The system of claim 1, wherein the classifying of the page components further comprises classifying the at least one page component which is activated by the mobile-device sensor information into a dynamic-component category which is one of the categories, and classifying the at least one page component which is not activated by the mobile-device sensor information into a static-component category which is another one of the categories.

5. The system of claim 1, wherein the at least one attribute is one of location configuration, style configuration, and interaction correlation configuration of the corresponding page component.

6. The system of claim 5, wherein the location configuration indicates the location of each of the page components in the mobile APP page, the style configuration indicates at least one of bonding boxes, fonts, and background colors of each of the page components, and the interaction correlation configuration indicates at least one of offsets, time-effectiveness, displays, and trigger conditions of each of the mobile-device sensor information.

7. The system of claim 1, wherein the interface module further receives a page selection command, and the processing module further selects at least a part of the mobile APP page according to the page selection command for the retrieving of page components.

8. The system of claim 1, wherein the generating of at least one mobile APP page template by the processing module means that the processing module generates a meta-template according to the categories and the usage counts, and generates at least one mobile APP page template corresponding to the meta-template according to the at least one attribute.

9. A method for generating a mobile Application (APP) page template, comprising:
receiving at least one mobile APP page via an operation interface;
retrieving, by a processing module, page components and mobile-device sensor information for activating at least one of the page components from the mobile APP page;
classifying, by the processing module, the page components into categories and keeping, by the processing module, a respective usage count and at least one attribute for each of the page components; and
generating, by the processing module, at least one mobile APP page template according to the categories, the usage counts, the attributes, and the mobile-device sensor information of the page components, and displaying, by the processing module, the mobile APP page template via the operation interface,
wherein the mobile APP page template comprises the mobile-device sensor information and at least one template component activated by the mobile-device sensor information.

10. The method of claim 9, wherein the mobile-device sensor information is generated by a mobile-device sensor.

11. The method of claim 9, further comprising:
retrieving, by the processing module, function setting information corresponding to the mobile-device sensor information from the mobile APP page,
wherein the mobile APP page template is generated further according to the function setting information, and the function setting information comprises at least one of the following:
information concerning an area in the mobile APP page for zoom-in or zoom-out of an image presentation;
information concerning a banner's location in the mobile APP page for presenting advertisement messages provided by a Global Positioning System (GPS);
information concerning a moving path for an image in the mobile APP page, which is dynamically adjusted by an accelerator;
information concerning a presentation area in the mobile APP page for activating a camera to capture an image; and
information concerning a presentation area of a button in the mobile APP page for activating a recording or playing function of a microphone.

12. The method of claim 9, wherein the classifying of the page components further comprises:
classifying the at least one page component which is activated by the mobile-device sensor information into a dynamic-component category which is one of the categories; and
classifying the at least one page component which is not activated by the mobile-device sensor information into a static-component category which is another one of the categories.

13. The method of claim 9, wherein the at least one attribute is one of location configuration, style configuration, and interaction correlation configuration of the corresponding page component.

14. The method of claim 13, wherein the location configuration indicates the location of each of the page components in the mobile APP page, the style configuration indicates at least one of bonding boxes, fonts, and background colors of each of the page components, and the interaction correlation information indicates at least one of offsets, time-effectiveness, displays, and trigger conditions of each of the mobile-device sensor information.

15. The method of claim 9, further comprising:
receiving a page selection command via the operation interface; and
selecting, by the processing module, at least a part of the mobile APP page according to the page selection command for the retrieving of page components.

16. The method of claim 9, wherein the generating of at least one mobile APP page template by the processing module comprises:
generating, by the processing module, a meta-template according to the categories and the usage counts; and
generating, by the processing module, at least one mobile APP page template corresponding to the meta-template according to the at least one attribute.

17. A machine-readable storage medium comprising a computer program, which, when executed, causes an electronic device to perform a method for generating a mobile Application (APP) page template, wherein the method comprises:
receiving at least one mobile APP page via an operation interface;
retrieving, by a processing module, page components and mobile-device sensor information for activating at least one of the page components from the mobile APP page;
classifying, by the processing module, the page components into categories and keeping, by the processing module, a respective usage count and at least one attribute for each of the page components; and
generating, by the processing module, at least one mobile APP page template according to the categories, the usage counts, the attributes, and the mobile-device sensor information of the page components, and displaying, by the process module, the mobile APP page template via the operation interface,
wherein the mobile APP page template comprises the mobile-device sensor information and at least one template component activated by the mobile-device sensor information.
